(19) United States
(12) Patent Application Publication
(10) Pub. No.: US 2013/0002896 A1
(43) Pub. Date: Jan. 3, 2013

(54) IMAGE CAPTURING APPARATUS AND CONTROL METHOD THEREOF

(75) Inventor: Yuki Fukushima, Yokohama-shi (JP)

(73) Assignee: CANON KABUSHIKI KAISHA, Tokyo (JP)

(21) Appl. No.: 13/481,328

(22) Filed: May 25, 2012

(30) Foreign Application Priority Data
Jun. 28, 2011 (JP) 2011-143391

(51) Int. Cl. H04N 5/225

(52) U.S. Cl. 348/220.1; 348/E05.024

(57) ABSTRACT

An image capturing apparatus capable of shooting a still image and recording a moving image, which controls to start still image shooting in response to a shooting instruction if it is set that moving image recording is not started in response to the shooting instruction, and controls to start moving image recording if it is set that the moving image recording is started in response to the shooting instruction.

### BACKGROUND OF THE INVENTION

1. Field of the Invention

The present invention relates to an image capturing apparatus and a control method thereof and, more particularly, to a control of an image capturing apparatus as a digital still camera having a moving image recording function.

2. Description of the Related Art

Some digital cameras capable of shooting a moving image assign a still image shooting instruction and a moving image shooting instruction to one shooting member, and switch the function of an operation member between still image shooting and moving image shooting according to whether the mode is a still image shooting mode or a moving image shooting mode (Japanese Patent Laid-Open No. 2006-033381). There are some cameras for which a shutter button for instructing still image shooting and a moving image button for instructing moving image shooting are separately provided. Japanese Patent Laid-Open No. 2006-033381 discloses a single-lens reflex digital camera for which a release button for instructing shooting preparation of still image shooting by pressing the button halfway and instructing still image shooting by fully pressing the button, and a moving image button for instructing to start moving image shooting are separately provided. With this arrangement, it is possible to shoot a still image using the release button in an arbitrary operation state (for example, a moving image shooting mode), which is preferable when still image shooting is considered to be important.

To eliminate the influence of hand shake, a shooting is often remotely instructed instead of using a camera body. Japanese Patent Laid-Open No. 07-036078 discloses a technique in which when a cable release connected with a camera is operated, a shooting instruction signal generated by fully pressing a shutter button is generated, and shooting is performed in response to the signal.

There is a demand to remotely instruct to start shooting without the influence of hand shake even in moving image shooting. Even if, however, a cable release which generates, as in Japanese Patent Laid-Open No. 07-036078, the same signal as that generated when a release button is fully pressed is connected with a camera which has a release button dedicated to still image shooting as in Japanese Patent Laid-Open No. 2010-081351, it is impossible to shoot a moving image. On the other hand, if the function of a release button in a moving image shooting mode is switched to a moving image shooting start instruction as in Japanese Patent Laid-Open No. 2006-033381, the advantage of being able to always shoot a still image using the release button is lost, which is not preferable for the user who considers still image shooting to be important.

Furthermore, a release button used for still image shooting is often arranged in a location in a camera where the user tends to hold it in a holding posture in which the influence of hand shake can be suppressed. It is, therefore, preferable for the user, who considers still image shooting to be important, to be able to perform moving image shooting while holding a camera with the hands in a posture in which hand shake can be suppressed, similarly to a still image.

### SUMMARY OF THE INVENTION

The present invention has been made in consideration of the aforementioned problems, and realizes an image capturing apparatus capable of shooting a still image and a moving image, which enables a user who considers moving image shooting to be important to instruct to start moving image shooting using a method in which the influence of hand shake is suppressed, similarly to a still image, and a control method for the image capturing apparatus.

In order to solve the aforementioned problems, the present invention provides an image capturing apparatus capable of shooting a still image and recording a moving image, comprising: an image sensing unit configured to capture an object image; a still image shooting unit configured to start still image shooting in response to a shooting instruction to perform still image shooting in a live view state in which the image captured by the image sensing unit is live-view displayed; a moving image recording unit configured to start, if it is possible to perform moving image recording in the live view state in which the image captured by the image sensing unit is live-view displayed, moving image recording in response to a recording instruction to perform moving image recording from a second operation unit different from a first operation unit which provides the shooting instruction to perform still image shooting; a setting unit configured to set so that the moving image recording unit starts moving image recording in response to a shooting instruction signal sent by the shooting instruction to perform the still image shooting; and a control unit configured to control the still image shooting unit to start, when the shooting instruction signal is sent, still image shooting in response to the shooting instruction signal if the setting unit does not set to start moving image recording in response to the shooting instruction signal and it is possible to perform the moving image recording, and control the moving image recording unit to start, when the shooting instruction signal is sent, moving image recording if the setting unit sets to start the moving image recording in response to the shooting instruction signal and it is possible to perform the moving image recording.

In order to solve the aforementioned problems, the present invention provides a method of controlling an image capturing apparatus, comprising: an image sensing step of capturing an object image; a still image shooting step of starting still image shooting in response to a shooting instruction to perform still image shooting in a live view state in which the image captured in the image capturing step is live-view displayed; a moving image recording step of starting, if it is possible to perform moving image recording in the live view state in which the image captured in the image capturing step is live-view displayed, moving image recording in response to a recording instruction to perform moving image recording from a second operation unit different from a first operation unit which provides the shooting instruction to perform still image shooting; a setting step of setting to start moving image recording in response to a shooting instruction signal sent by the shooting instruction to perform the still image shooting; and a control step of controlling to start, when the shooting instruction signal is sent, still image shooting in response to the shooting instruction signal if moving image recording is not set to start in response to the shooting instruction signal in the setting step and it is possible to perform the moving image recording, and controlling to start, when the shooting instruction signal is sent, moving image recording if the moving image recording is set to start in response to the shooting instruction signal in the setting step and it is possible to perform moving image recording.

According to the present invention, it is possible to start moving image shooting by an operation member for use in still image shooting without deteriorating the operability of still image shooting.

Further features of the present invention will become apparent from the following description of exemplary embodiments (with reference to the attached drawings).

### BRIEF DESCRIPTION OF THE DRAWINGS

FIG. 1 is a block diagram showing the configuration of an image capturing apparatus according to an embodiment of the present invention;

FIG. 2A is a view showing the outer appearance of the image capturing apparatus according to the embodiment when seen from the front side;

FIG. 2B is a view showing the outer appearance of the image capturing apparatus according to the embodiment when seen from the back side;

FIG. 3 is a flowchart illustrating moving image recording start setting processing according to a shooting instruction signal;

FIG. 4A is a view showing an example of a GUI screen for performing moving image recording start setting according to the shooting instruction signal;

FIG. 4B is a view showing an example of a GUI screen when the moving image recording start setting according to the shooting instruction signal is disabled;

FIG. 5 is a flowchart illustrating processing of starting moving image recording or still image shooting during a live view operation;

FIG. 6 is a flowchart illustrating moving image recording/still image shooting start determination processing in FIG. 5; and

FIG. 7 is a view showing an example of a live view screen in the moving image recording start setting according to the shooting instruction signal.

### DESCRIPTION OF THE EMBODIMENTS

Embodiments of the present invention will be described in detail below.

<Apparatus Configuration>

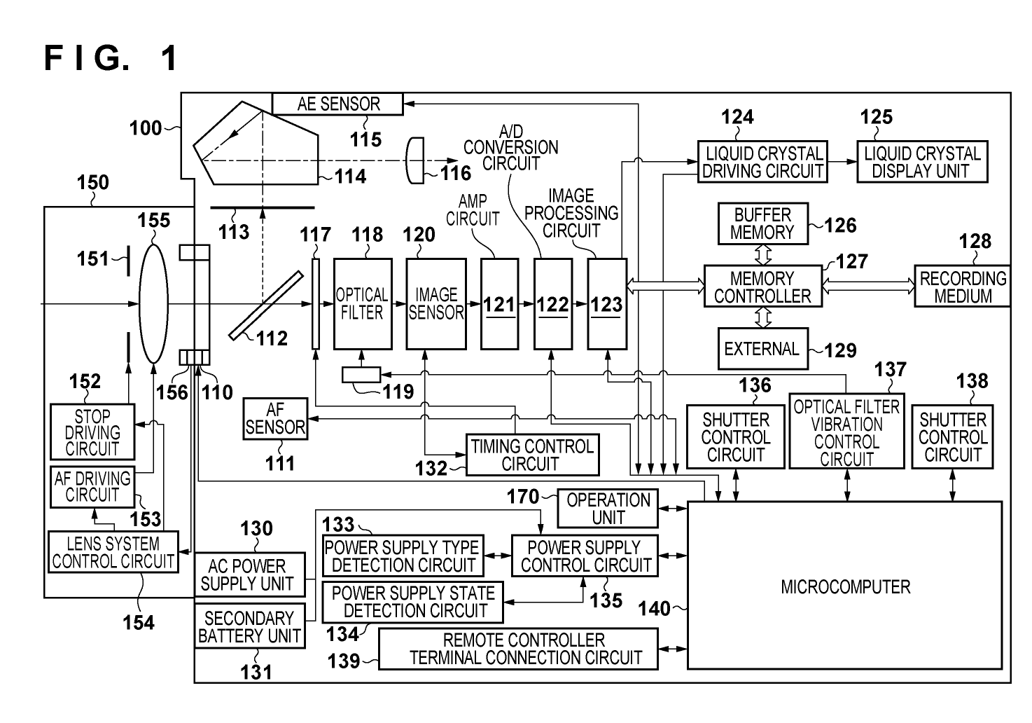

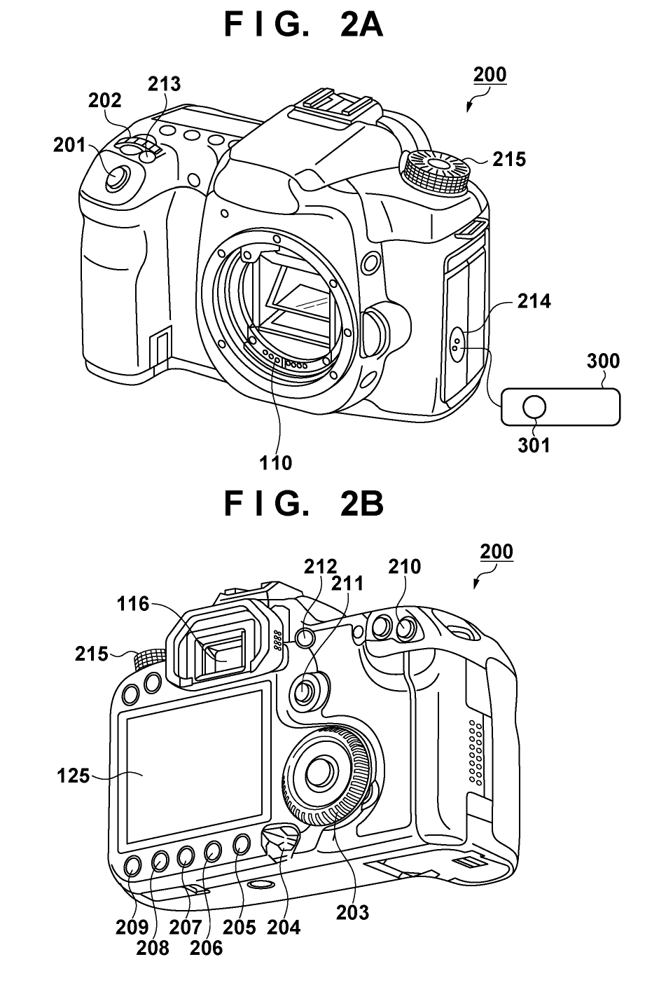

The function and outer appearance of an image capturing apparatus 100 (a lens-interchangeable single-lens reflex digital camera will be exemplified in an embodiment) according to the embodiment of the present invention will be described with reference to FIGS. 1, 2A, and 2B.

Referring to FIG. 1, a lens unit 150 incorporates an interchangeable shooting lens 155. The shooting lens 155 generally includes a plurality of lenses but is simply shown as one lens for descriptive convenience. A communication terminal 156 is used by the lens unit 150 to communicate with the image capturing apparatus 100, and a communication terminal 110 is used by the image capturing apparatus 100 to communicate with the lens unit 150. The lens unit 150 communicates with a microcomputer 140 via the communication terminals 156 and 110 to cause an internal lens system control circuit 154 to control an aperture stop 151 through an aperture stop driving circuit 152. Furthermore, the lens unit 150 communicates with the microcomputer 140 via the communication terminals 156 and 110 to move the position of the shooting lens 155 through an AF driving circuit 153 to an in-focus position.

An AE sensor 115 measures the luminance of an object through the lens unit 150.

An AF sensor 111 outputs a defocus amount to the microcomputer 140. The microcomputer 140 controls the lens unit 150 based on the defocus amount.

The microcomputer 140 instructs, in exposure, to turn up/down a quick return mirror 112 by an actuator (not shown).

The user can check the focus and composition of an optical object image which has been obtained through the lens unit 150 by observing a focusing screen 113 through a pentaprism 114 and a finder 116.

A focal-plane shutter 117 can freely control the exposure time of an image sensor 120 under the control of the microcomputer 140.

An optical filter 118 generally includes a low-pass filter, which cuts a high-frequency component of light incident from the focal-plane shutter 117 to guide an object image to the image sensor 120.

The image sensor 120 is generally, for example, a CCD or CMOS sensor, which photoelectrically converts an optical image formed on the image sensor 120 through the lens unit 150, and captures the image as an electric signal.

An AMP circuit 121 amplifies the captured electric signal with a gain corresponding to set shooting sensitivity.

An A/D conversion circuit 122 converts, into a digital signal, an analog signal converted into the electric signal by the image sensor 120.

An image processing circuit 123 executes filter processing, color conversion processing, and gamma/knee processing for the image data converted into the digital signal by the A/D conversion circuit 122, and outputs the obtained data to a memory controller 127. Furthermore, the image processing circuit 123 incorporates a D/A conversion circuit (not shown). The image processing circuit 123 can also convert, into an analog signal, the image data converted into the digital signal by the A/D conversion circuit 122 or the image data input by the memory controller 127, and output the obtained analog signal to a liquid crystal display unit 125 via a liquid crystal driving circuit 124. The microcomputer 140 can switch between the image processing and the display processing which are executed by the image processing circuit 123. The microcomputer 140 also performs white balance adjustment based on the color balance information of the shot image.

The liquid crystal display unit 125 is a back monitor for displaying an image. The monitor is not limited to a liquid crystal display and any display which displays an image such as an organic EL display may be used.

The memory controller 127, for example, stores unprocessed image data input from the image processing circuit 123 in a buffer memory 126, and stores image data having undergone image processing in a recording medium 128. Furthermore, the memory controller 127 fetches image data from the buffer memory 126 or recording medium 128, and outputs it to the image processing circuit 123. The memory controller 127 can also store, in the recording medium 128, image data transmitted via an external interface 129, and output image data stored in the recording medium 128 to an external apparatus via the external interface 129. Examples of the external interface are USB, IEEE, and HDMI interfaces.

The recording medium 128 is detachable from the image capturing apparatus 100 such as a semiconductor memory card. Note that the recording medium 128 may be an internal memory. The microcomputer 140 causes a timing control circuit 132 to control the timing of driving the image sensor 120.

A power supply control circuit 135 controls a power supply to be supplied with a power from an AC power supply unit 130 or secondary battery unit 131. In response to a control instruction from the microcomputer 140, the power supply control circuit 135 turns on/off the power supply. Furthermore, the power supply control circuit 135 notifies the microcomputer 140 of information about the current power supply state detected by a power supply state detection circuit 134 and information about the current power supply type detected by a power supply type detection circuit 133.

The microcomputer 140 causes a shutter control circuit 136 to control the focal-plane shutter 117.

An optical filter vibration control circuit 137 vibrates a plezoelectric element 119 connected to the optical filter 118 with predetermined vibration (a predetermined amplitude, vibration time, and vibration axis direction) according to a control instruction from the microcomputer 140.

A non-volatile memory 138 is a non-volatile recording medium such as an EEPROM, which can save setting values such as a shutter speed, aperture value, and shooting sensitivity that have been arbitrarily set by the user, and other various kinds of data even if the image capturing apparatus 100 is not powered on.

A remote controller terminal connection detection circuit 139 detects whether the remote controller 300 is connected to a remote controller connection terminal 214 (see FIGS. 2A and 2B) of the image capturing apparatus 100, and notifies the microcomputer 140 of a detection result.

An operation unit 170 includes various operation members as an input unit for accepting a user operation. As shown in FIGS. 2A and 2B, the operation unit 170 includes at least a release button 201, a main electronic dial 202, a sub electronic dial 203, a power switch 204, a protect button 205, a menu button 206, a delete button 207, a zoom mode button 208, a playback instruction button 209, a single/multi switching button 210, and a multi controller 211.

The microcomputer 140 serves as a control unit for controlling each component included in the image capturing apparatus 100. The microcomputer 140 maps a program recorded in the non-volatile memory 138 on the work area of the non-volatile memory such as a RAM, and executes the program to perform various processes of a flowchart (to be described later).

FIG. 2A is a view showing the outer appearance of the image capturing apparatus 100 when seen from the front side. FIG. 2B is a view showing the outer appearance of the image capturing apparatus when seen from the back side. The same reference numerals denote the same parts as those in FIG. 1.

The release button 201 serves as an operation unit for providing a shooting preparation instruction and a shooting instruction. When the user presses this button halfway, the microcomputer 140 is notified of a shooting preparation instruction to measure the luminance of an object and to perform focusing. When the user fully presses this button, the microcomputer 140 is notified of a shooting operation instruction and the shutter is released to shoot an image. For descriptive convenience, Sw1 represents a signal of which the microcomputer 140 is electrically notified when the release button 201 is pressed halfway, and Sw2 (a shooting instruction signal) represents a signal of which the microcomputer 140 is electrically notified when the release button 201 is fully pressed.

The main electronic dial 202 is a turning operation member. The user turns the main electronic dial 202 to set setting values such as a shutter speed and aperture value or to perform fine adjustment of a zoom magnification in a zoom mode.

The sub electronic dial 203 is a turning operation member. The user turns the sub electronic dial 203 to set setting values such as an aperture value and exposure correction or to perform an operation of forwarding one frame in an image display state.

The power switch 204 is an operation member for turning on or off the power.

The protect button 205 is used to perform protect or rating processing for an image saved in the recording medium 128 incorporated in or inserted into the image capturing apparatus 100.

The menu button 206 is used to display various setting screens on the liquid crystal display unit 125.

The delete button 207 is used to instruct to delete an image saved in the recording medium 128 incorporated in or inserted into the image capturing apparatus 100.

The zoom mode button 208 is used to accept, in a playback state, an operation of instructing to transit to a zoom-in mode (a zoom mode start instruction) and an operation of instructing to exit the zoom-in mode (a zoom mode end instruction).

The playback instruction button 209 is used to display, on the liquid crystal display unit 125, an image saved in the recording medium 128 incorporated in or inserted into the image capturing apparatus 100.

The single/multi switching button 210 is used to instruct to lock the measured luminance of the object, or to instruct to switch between single display and multi display in a playback state.

The multi controller 211 is an operation member which is operable in a plurality of directions, and is used to set a focusing point as an autofocus start point or to move a zoom frame (zooming range) in an enlarged image display state.

A live view start button 212 enables the image capturing apparatus 100 to transit to a live view state when it is pressed by the user. The live view state indicates a state in which an image captured by the image sensor 120 is live-view displayed.

A moving image start button 213 enables to start moving image recording when it is pressed by the user to notify the microcomputer 140 of a moving image recording instruction.

A shooting mode dial 215 is a dial operation member used by the user to select and set a desired shooting mode from a plurality of shooting modes. Assume that the plurality of shooting modes include a manual mode, a shutter-speed priority mode, an aperture priority mode, a program AE mode, a valve mode, a full auto mode, a flash off mode, a creative full auto mode, a portrait mode, a landscape mode, a close-up mode, a sports mode, a night portrait mode, and a moving image mode.

The remote controller connection terminal 214 is used to connect a remote controller 300, and is electrically connected with the release button 201.

The remote controller 300 is connected by wire to be used for shooting an image by a remote operation from outside without pressing the release button 201.

A remote release button 301 is provided for the remote controller 300. It is also possible to perform a 2-stage operation for the remote release button 301. That is, it is possible to press the button 301 halfway and to fully press the button 301. Assume that the remote controller 300 is connected to the remote controller connection terminal 214. In this case, if the remote release button 301 is pressed halfway, the microcomputer 140 is notified of Sw1, and if the button 301 is fully pressed, the microcomputer 140 is notified of Sw2. By connecting the remote controller 300 to the remote controller connection terminal 214 and pressing the remote release button 301, the user can shoot an image without pressing the release button 201.

<Moving Image Recording Start Setting>

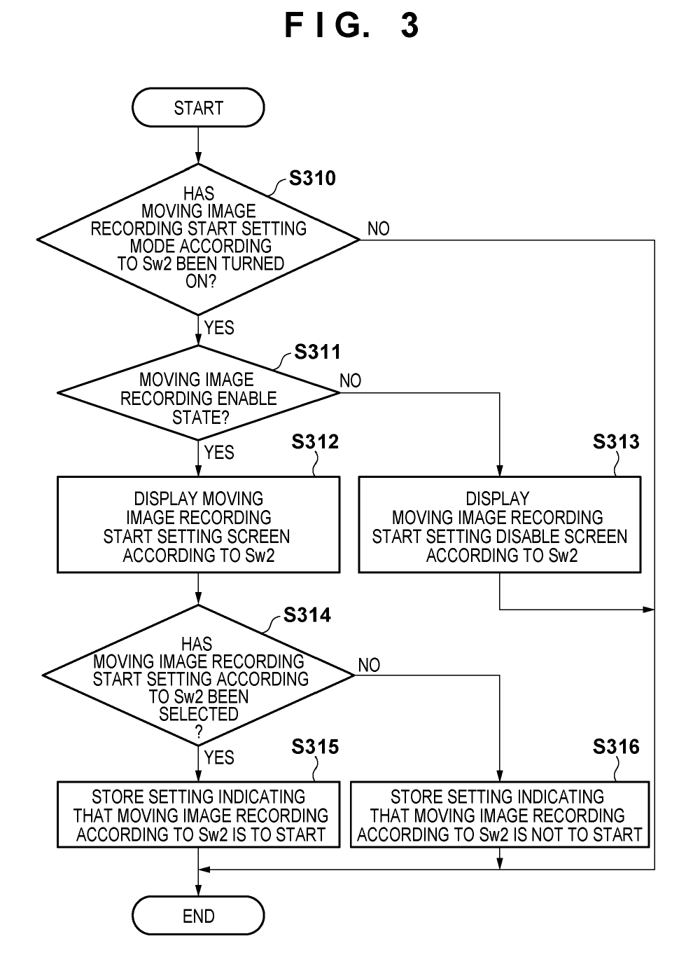

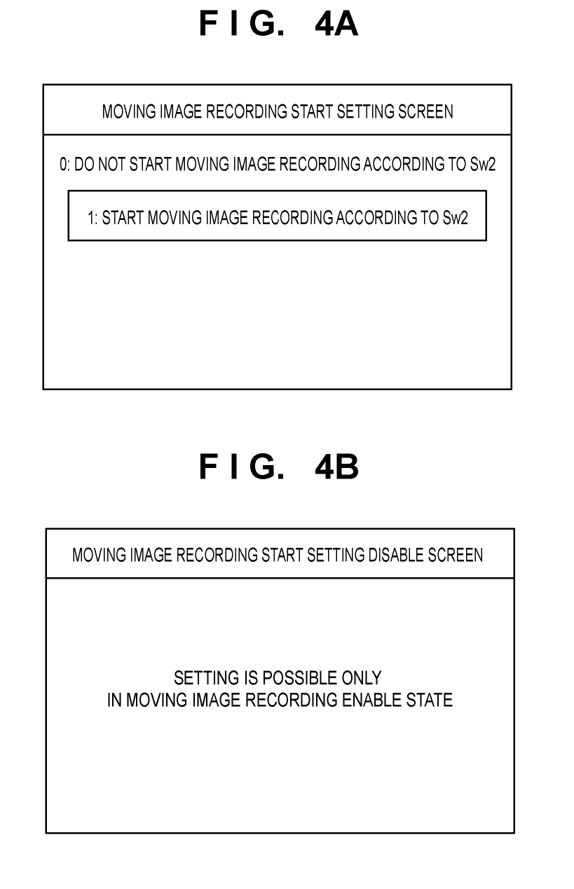

Processing for setting the image capturing apparatus 100 of this embodiment to be in a mode of starting moving image recording according to a shooting instruction signal (Sw2) will be described below with reference to FIGS. 3, 4A, and 4B. Note that the following processing is implemented when the microcomputer 140 maps a program recorded in the non-volatile memory 138 on the work area of the non-volatile memory such as a RAM, and executes the program.

Referring to FIG. 3, in step S310, the microcomputer 140 determines whether a moving image recording start setting mode according to Sw2 has been turned on. If the mode has been turned on, the process advances to step S311; otherwise, the process ends. Note that an operation of turning on the moving image recording start setting mode is an operation of opening a menu for setting whether to perform moving image recording start setting according to Sw2.

In step S311, the microcomputer 140 determines whether the image capturing apparatus 100 is in a moving image recording enable state. If the apparatus 100 is in a moving image recording enable state, the process advances to step S312; otherwise, the process advances to step S313. The moving image recording enable state indicates a moving image mode in which it is possible to record a moving image. It is possible to transit to the mode by setting the apparatus to be in a moving image mode by operating the shooting mode dial 215 or pressing the menu button 206 to set to enter the moving image recording enable state. If the apparatus enters the moving image recording enable state, black bands indicating an aspect ratio for moving image recording, and information such as a moving image recording enable time are displayed.

In step S312, the microcomputer 140 outputs a control instruction to the image processing circuit 123 and the liquid crystal driving circuit 124 to display a GUI screen, as shown in FIG. 4A, on which it is possible to perform the moving image recording start setting according to Sw2. Note that in initial settings, moving image recording according to Sw2 is set not to start (that is, still image shooting is performed according to Sw2 even in the moving image recording enable state).

In step S313, the microcomputer 140 outputs a control instruction to the image processing circuit 123 and the liquid crystal driving circuit 124 to display a GUI screen, as shown in FIG. 4B, which indicates that the moving image recording start setting according to Sw2 is disabled.

In step S314, it is determined on the GUI screen shown in FIG. 4A whether the moving image recording start setting according to Sw2 has been selected. If the setting has been selected, the process advances to step S315; otherwise, the process advances to step S316.

In step S315, setting information indicating that moving image recording according to Sw2 is to start is stored is stored in the non-volatile memory 138.

In step S316, setting information indicating that moving image recording according to Sw2 is not to start is stored in the non-volatile memory 138.

With the above control operation, it is possible to set to start moving image recording according to Sw2 only when the image capturing apparatus is in the moving image recording enable state, that is, the user intends to record a moving image. This prevents the error setting of starting moving image recording according to Sw2 when the user wants to shoot a still image.

<Moving Image Recording and Still Image Shooting>

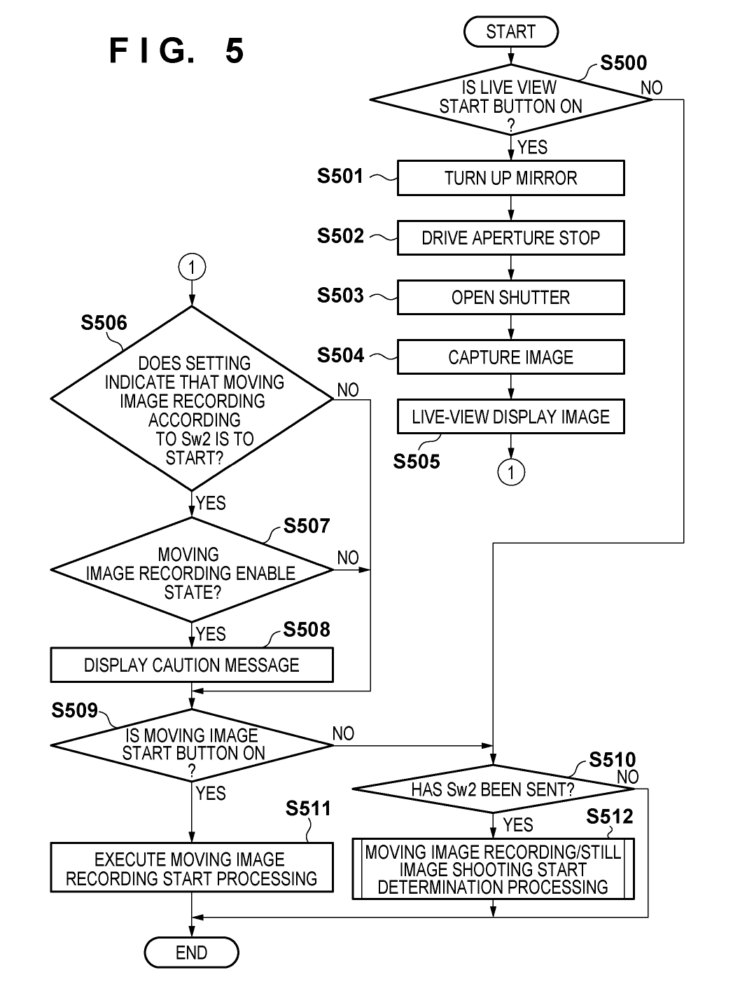

The operation of the image capturing apparatus when Sw2 is sent during a live view operation will be described next with reference to FIGS. 5 to 7. Note that the following processing is implemented when the microcomputer 140 maps a program recorded in the non-volatile memory 138 on the work area of the non-volatile memory such as a RAM, and executes the program.

Referring to FIG. 5, in step S500, the microcomputer 140 determines whether the live view start button 212 has been pressed. If the button has been pressed, the process advances to step S501; otherwise, the process advances to step S510.

In step S501, the microcomputer 140 turns up the quick return mirror 112.

In step S502, the microcomputer 140 transmits a set aperture value to the lens system control circuit 154 through the communication terminals 156 and 110, and causes the aperture stop driving circuit 152 to drive the aperture stop 151.

In step S503, the microcomputer 140 opens the focal-plane shutter 117.

In step S504, the microcomputer 140 causes the timing control circuit 132 to control the timing of driving the image sensor 120 based on a set shutter speed. Furthermore, the microcomputer 140 causes the AMP circuit 121 to amplify a shooting signal with a gain corresponding to a set ISO value, causes the A/D conversion circuit 122 to convert the signal into a digital signal, and then causes the image processing circuit 123 to capture image data in the buffer memory 126.

In step S505, the microcomputer 140 causes the memory controller 127 to convert the image data captured in the buffer memory 126 into an analog signal, and causes the liquid crystal driving circuit 124 to output the signal to the liquid crystal display unit 125, thereby transiting to a live view state.

In step S506, the microcomputer 140 reads out the setting information set in step S315 or S316 of FIG. 3 from the non-volatile memory 138. If the setting information indicates that moving image recording according to Sw2 is to start, the process advances to step S507; otherwise, the process advances to step S509.

In step S507, the microcomputer 140 determines whether the image capturing apparatus 100 is in the moving image recording enable state. If the apparatus 100 is in the moving image recording enable state, the process advances to step S508; otherwise, the process advances to step S509.

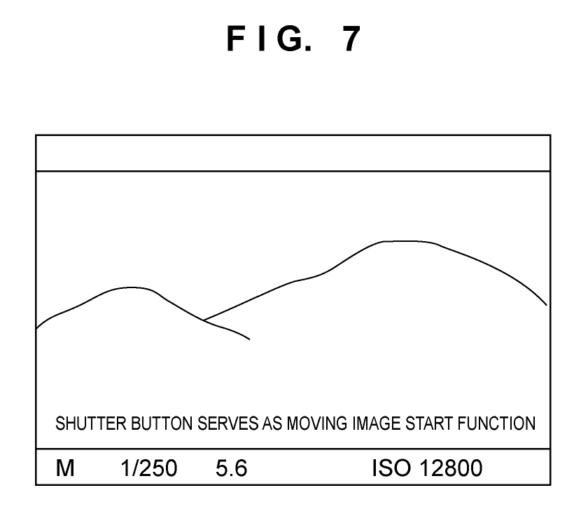

In step S508, the microcomputer 140 displays, on a live view screen, a caution indicating that it is impossible to perform still image shooting according to Sw2, like a live view screen shown in FIG. 7. Since still image shooting is generally performed by fully pressing the release button 201, the user may misunderstand that it is possible to perform still image shooting, and erroneously press the release button 201. By displaying a caution in step S508 to make the user recognize that moving image recording is to start, however, it is possible to prevent such an error operation.

In step S509, the microcomputer 140 determines whether the moving image start button 213 has been pressed. If the button has been pressed, the process advances to step S511; otherwise, the process advances to step S510.

In step S510, the microcomputer 140 determines whether Sw2 has been sent. If Sw2 has been sent, the process advances to step S512; otherwise, the process ends. Note that as described above, Sw2 is sent when the release button 201 or the remote release button 301 of the remote controller 300 connected to the remote controller connection terminal 214 is fully pressed.

In step S511, the microcomputer 140 executes moving image recording start processing. This moving image recording start processing records a moving image file with audio which includes a plurality of time-series frame images with a predetermined frame rate. The moving image file is recorded as an AVI, MPEG, JPEG, or H.264 file. Depending on a moving image encoding scheme, compression encoding is performed in consideration of time direction information.

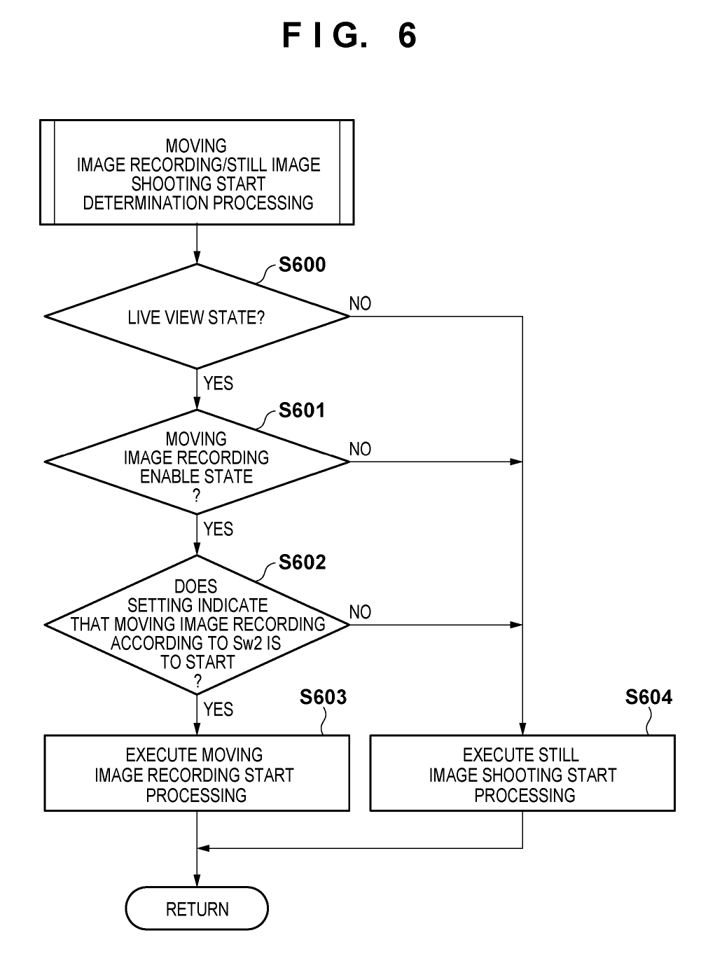

In step S512, the microcomputer 140 determines whether to start moving image recording or still image shooting, and executes corresponding processing. Processing in step S512 will be described later with reference to FIG. 6.

<Moving Image Recording/Still Image Shooting Start Determination>

The moving image recording/still image shooting start determination processing in step S512 of FIG. 5 will be described with reference to FIG. 6.

Referring to FIG. 6, in step S600, the microcomputer 140 determines whether the image capturing apparatus 100 is in a live view state. If the apparatus 100 is in a live view state, the process advances to step S601; otherwise, the process advances to step S604.

In step S601, the microcomputer 140 determines whether the image capturing apparatus 100 is in a moving image recording enable state. If the apparatus 100 is in a moving image recording enable state, the process advances to step S602; otherwise, the process advances to step S604.

In step S602, the microcomputer 140 reads out the setting information set in step S315 or S316 of FIG. 3 from the non-volatile memory 138. If the setting information indicates that moving image recording according to Sw2 is to start, the process advances to step S603; otherwise, the process advances to step S604.

In step S603, the microcomputer 140 executes processing of starting moving image recording. This moving image recording start processing records a moving image file with audio which includes a plurality of time-series frame images with a predetermined frame rate. The moving image file is recorded as an AVI, MPEG, JPEG, or H.264 file. Depending on a moving image encoding scheme, compression encoding is performed in consideration of time direction information. Since moving image recording according to Sw2 starts as described above, the user can start moving image recording by fully pressing the release button 201 or the remote release button 301 of the remote controller 300 connected to the remote controller connection terminal 214.

In step S604, the microcomputer 140 executes processing of starting still image shooting. The still image recording processing generates and records a still image file such as a RAW image file, JPEG file, TIFF file, GIF file, or BMP file.

As described above, the user can preset whether to start still image shooting according to Sw2 (not to start moving image recording) or to start moving image recording. By setting to start moving image recording according to Sw2, therefore, the user who considers moving image recording to be important can perform moving image recording by pressing the release button 201 that is easy to operate when holding the camera in a posture in which the influence of hand shake is small.

By connecting the remote controller 300 with the image capturing apparatus 100, it is possible to start moving image recording by operating the remote controller 300 without touching the body of the image capturing apparatus 100, and to perform moving image recording in an environment where there is no influence of hand shake.

Note that even if the user sets to start moving image recording according to Sw2, a moving image recording start instruction may be provided only when Sw2 is sent by operating the remote release button 301 of the remote controller 300. That is, when Sw2 is sent while the remote controller 300 is not used, still image shooting may start. In this case, for example, after determining in step S601 of FIG. 6 whether the apparatus is in the moving image recording enable state, the process need only advance to step S602 if it is determined based on a detection signal input from the remote controller terminal connection detection circuit 139 that the remote controller 300 is connected, and the process need only advance to step S604 if it is determined based on the detection signal that the controller 300 is not connected. With this operation, only if the remote controller 300 is connected, it is possible to start moving image recording when Sw2 is sent. If the remote controller 300 is not connected, it is possible to start still image shooting when Sw2 is sent.

This enables to perform moving image recording using the remote controller 300 while suppressing the influence of hand shake, and the release button 201 provided for the image capturing apparatus 100 can be dedicated to still image shooting. It is, therefore, possible to reduce the inconvenience that the user is confused whether the current function of the release button 201 is to record a moving image or to shoot a still image.

Note that as a method of setting, in advance, to start moving image recording by the user, in addition to “0: do not start moving image recording according to Sw2” (step S604 of FIG. 6) and “1: start moving image recording according to Sw2” (step S603 of FIG. 6), an option “2: start moving image recording only when remote controller is connected” may be added to the GUI screen of FIG. 4B.

Note that one hardware component may execute the control of the microcomputer 140, or a plurality of hardware components may share the processing, thereby controlling the apparatus as a whole.

Although the embodiment for implementing the present invention has been described in detail, the present invention is not limited to the specific embodiment, and includes various modes without departing from the spirit and scope thereof. Furthermore, the above-described embodiment is merely an example of the present invention, and respective embodiments can be combined as needed.

Although a case in which the present invention is applied to a single-lens reflex digital camera has been described in the above-described embodiment, the present invention is not limited to this, and is applicable to any image capturing apparatus which can shoot a moving image and still image. That is, the present invention is applicable to a personal computer with a camera, a PDA with a camera, a cellular phone terminal with a camera, a music player with a camera, a game machine with a camera, an electronic book reader with a camera, and the like.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-143391, filed Jun. 28, 2011, which is hereby incorporated by reference herein in its entirety.

What is claimed is:

1. An image capturing apparatus capable of shooting a still image and recording a moving image, comprising:
an image sensing unit configured to capture an object image;
a still image shooting unit configured to start still image shooting in response to a shooting instruction to perform still image shooting in a live view state in which the image captured by said image sensing unit is live-view displayed;
a moving image recording unit configured to start, if it is possible to perform moving image recording in the live view state in which the image captured by said image sensing unit is live-view displayed, moving image recording in response to a recording instruction to perform moving image recording from a second operation unit different from a first operation unit which provides the shooting instruction to perform still image shooting;
a setting unit configured to set so that said moving image recording unit starts moving image recording in response to a shooting instruction signal sent by the shooting instruction to perform the still image shooting; and
a control unit configured to
control said still image shooting unit to start, when the shooting instruction signal is sent, still image shooting in response to the shooting instruction signal if said setting unit does not set to start moving image recording in response to the shooting instruction signal and it is possible to perform the moving image recording, and
control said moving image recording unit to start, when the shooting instruction signal is sent, moving image recording if said setting unit sets to start the moving image recording in response to the shooting instruction signal and it is possible to perform the moving image recording.

2. The apparatus according to claim 1, further comprising:
a connection unit configured to connect with a remote controller for remotely operating said still image shooting unit,
wherein the shooting instruction signal is sent in response to a shooting instruction from the remote controller connected with said connection unit.

3. The apparatus according to claim 2, wherein the remote controller is electrically connected with said connection unit.

4. The apparatus according to claim 2, wherein, if the remote controller is not connected with said connection unit, even when said setting unit sets to start moving image recording in response to the shooting instruction signal, and it is possible to perform the moving image recording, said control unit controls said still image shooting unit to start, when the shooting instruction signal is sent, still image shooting instead of moving image recording in response to the shooting instruction signal.

5. The apparatus according to claim 2, further comprising:
a connection detection unit configured to detect whether the remote controller is connected with said connection unit.

6. The apparatus according to claim 2, wherein said setting unit is capable of setting any of a plurality of setting candidates including a first setting in which moving image recording does not start in response to the shooting instruction signal, a second setting in which moving image recording starts in response to a shooting instruction signal sent by operating the first operation unit, and a third setting in which the moving image recording does not start in response to a shooting instruction signal sent by operating the first operation unit, and the moving image recording starts in response to a shooting instruction signal sent by operating the remote controller.

7. The apparatus according to claim 1, further comprising:
a display control unit configured to control to display, on a display unit, options settable by said setting unit,
wherein said setting unit sets contents which have been selected by a user from the options displayed by said display control unit.

8. The apparatus according to claim 1, wherein when said setting unit sets to start moving image recording in response to the shooting instruction signal and it is possible to perform the moving image recording, said control unit controls said moving image recording unit to start moving image recording when a recording instruction is sent from the second operation unit.

9. The apparatus according to claim 1, wherein
said setting unit is capable of setting, only in a moving image mode in which it is possible to perform the moving image recording, so that said moving image recording unit starts moving image recording in response to the shooting instruction signal, and
said control unit displays a caution when said setting unit has set to start moving image recording in response to the shooting instruction signal in the live view state.

10. The apparatus according to claim 1, wherein
a still image shot by said still image shooting unit is recorded as a still image file, and
a moving image recorded by said moving image recording unit is recorded as a moving image file with audio which includes a plurality of time-series frame images with a predetermined frame rate.

11. A method of controlling an image capturing apparatus, comprising:
an image sensing step of capturing an object image;
a still image shooting step of starting still image shooting in response to a shooting instruction to perform still image shooting in a live view state in which the image captured in the image capturing step is live-view displayed;
a moving image recording step of starting, if it is possible to perform moving image recording in the live view state in which the image captured in the image capturing step is live-view displayed, moving image recording in response to a recording instruction to perform moving image recording from a second operation unit different from a first operation unit which provides the shooting instruction to perform still image shooting;
a setting step of setting to start moving image recording in response to a shooting instruction signal sent by the shooting instruction to perform the still image shooting; and
a control step of
controlling to start, when the shooting instruction signal is sent, still image shooting in response to the shooting instruction signal if moving image recording is not set to start in response to the shooting instruction signal in the setting step and it is possible to perform the moving image recording, and
controlling to start, when the shooting instruction signal is sent, moving image recording if the moving image recording is set to start in response to the shooting instruction signal in the setting step and it is possible to perform moving image recording.

12. A non-transitory computer-readable storage medium storing a program for causing a computer to execute the control method according to claim 11.
